(19) United States
(12) Patent Application Publication
(10) Pub. No.: US 2025/0336333 A1
(43) Pub. Date: Oct. 30, 2025

(54) PIXEL CIRCUIT

(71) Applicant: AUO Corporation, Hsinchu City (TW)

(72) Inventors: Ming-Yang Deng, Hsinchu City (TW); Ming-Hung Chuang, Hsinchu City (TW)

(73) Assignee: AUO Corporation, Hsinchu City (TW)

(21) Appl. No.: 18/963,520

(22) Filed: Nov. 28, 2024

(30) Foreign Application Priority Data
Apr. 24, 2024 (TW) 113115174

(51) Int. Cl. G09G 3/32; G09G 3/00

(52) U.S. Cl. CPC G09G 3/32; G09G 3/006; G09G 2300/0842; G09G 2300/0861; G09G 2310/08; G09G 2320/0223; G09G 2330/12

(57) ABSTRACT

A pixel circuit includes a light emitting element, a first transistor, a capacitor, a driving circuit, a light emitting control circuit, a reset circuit, a voltage dividing circuit, and a data input circuit. The light emitting element receives a supply voltage. The first transistor receives an operating high voltage and a scan signal, and is coupled to the light emitting element. The driving circuit provides a driving current based on a driving voltage. The light emitting control circuit is coupled between the driving circuit and a ground voltage, and receives a light emitting signal. The reset circuit is coupled between a reference voltage and the driving voltage, and receives the scan signal. The voltage dividing circuit is coupled between the driving voltage and the capacitor, and receives the light emitting signal. The data input circuit is coupled between the capacitor and a data input signal, and receives the scan signal.

### CROSS-REFERENCE TO RELATED APPLICATION

This application claims the priority benefit of Taiwan application serial no. 113115174, filed on Apr. 24, 2024. The entirety of the above-mentioned patent application is hereby incorporated by reference herein and made a part of this specification.

### BACKGROUND

### Technical Field

The disclosure relates to a pixel circuit, and in particular to a pixel circuit capable of voltage compensation.

### Description of Related Art

In a conventional display device, a driving current of a pixel circuit is easily affected by a threshold voltage of a driving transistor, so voltage compensation of the threshold voltage is required. The pixel circuit usually needs to be provided with multiple alternating current signal lines to perform the voltage compensation.

However, providing the alternating current signal lines means that the layout area of the pixel circuit increases, causing a decrease in aperture ratio, thereby causing a decrease in the brightness of the display device. Therefore, how to reduce the number of alternating current signal lines in a pixel circuit with a voltage compensation function is one of the research focuses of persons skilled in the art.

### SUMMARY

The disclosure provides a pixel circuit, which is only provided with two alternating current signal lines and can compensate for a driving current.

A pixel circuit of the disclosure includes a light emitting element, a first transistor, a capacitor, a driving circuit, a light emitting control circuit, a reset circuit, a voltage dividing circuit, and a data input circuit. The light emitting element has an anode and a cathode, and the cathode receives a supply voltage. The first transistor has a first terminal receiving an operating high voltage, a control terminal receiving a scan signal, and a second terminal coupled to the cathode of the light emitting element. The capacitor has a first terminal and a second terminal. The driving circuit is coupled between the cathode of the light emitting element and the second terminal of the capacitor, and the driving circuit receives a driving voltage to provide a driving current based on the driving voltage. The light emitting control circuit is coupled between the driving circuit and a ground voltage, and receives a light emitting signal. The reset circuit is coupled between a reference voltage and the driving voltage, and receives the scan signal. The voltage dividing circuit is coupled between the driving voltage and the first terminal of the capacitor, and receives the light emitting signal. The data input circuit is coupled between the first terminal of the capacitor and the data input signal, and receives the scan signal.

Based on the above, in the pixel circuit of the embodiment of the disclosure, the pixel circuit may only use two control signals (that is, the scan signal and the light emitting signal) to control the operation of the pixel circuit. In other words, the pixel circuit may only need to use two signal lines to complete the circuit layout of the signal lines, thereby reducing a circuit area of the pixel circuit to increase an aperture ratio of the pixel circuit.

In order for the features and advantages of the disclosure to be more comprehensible, the following specific embodiments are described in detail in conjunction with the drawings.

### BRIEF DESCRIPTION OF THE DRAWINGS

FIG. 1 is a schematic system diagram of a pixel circuit according to an embodiment of the disclosure.

FIG. 2 is a schematic circuit diagram of a pixel circuit according to an embodiment of the disclosure.

FIG. 3 is a schematic timing diagram of signals in a pixel circuit according to an embodiment of the disclosure.

FIG. 4A is a schematic timing diagram of signals in a display device according to an embodiment of the disclosure.

FIG. 4B is a schematic timing diagram of signals in a display device according to another embodiment of the disclosure.

FIG. 4C is a schematic timing diagram of signals in a display device according to another embodiment of the disclosure.

FIG. 4D is a schematic timing diagram of signals in a display device according to another embodiment of the disclosure.

FIG. 5 is a schematic circuit diagram of a pixel circuit according to another embodiment of the disclosure.

### DESCRIPTION OF THE EMBODIMENTS

Unless otherwise defined, all terms (including technical and scientific terms) used herein have the same meaning as commonly understood by persons skilled in the art of the disclosure. It will be further understood that terms such as those defined in commonly used dictionaries should be interpreted as having meanings consistent with the meanings in the related art and the context of the disclosure, and will not be interpreted as having idealized or overly formal meanings unless explicitly defined herein.

It should be understood that although terms such as “first”, “second”, and “third” may be used herein to describe various elements, components, regions, layers, and/or parts, the elements, components, regions, and/or parts are not limited by the terms. The terms are only used to distinguish one element, component, region, layer, or part from another element, component, region, layer, or part. Therefore, a first “element”, “component”, “region”, “layer”, or “part” discussed below may be referred to as a second element, component, region, layer, or part without departing from the teachings herein.

The terms used herein are only for the purpose of describing specific embodiments and are not limiting. As used herein, unless the content clearly indicates otherwise, the singular forms “a”, “one”, and “the” are intended to include plural forms, including “at least one”. “Or” represents “and/or”. As used herein, the term “and/or” includes any and all combinations of one or more of the relevant listed items. It should also be understood that when used in the specification, the terms “containing” and/or “including” designate the presence of the feature, the region, the entirety, the step, the operation, the element, and/or the component, but do not exclude the presence or the addition of one or more other features, regions, entireties, steps, operations, elements, components, and/or combinations thereof.

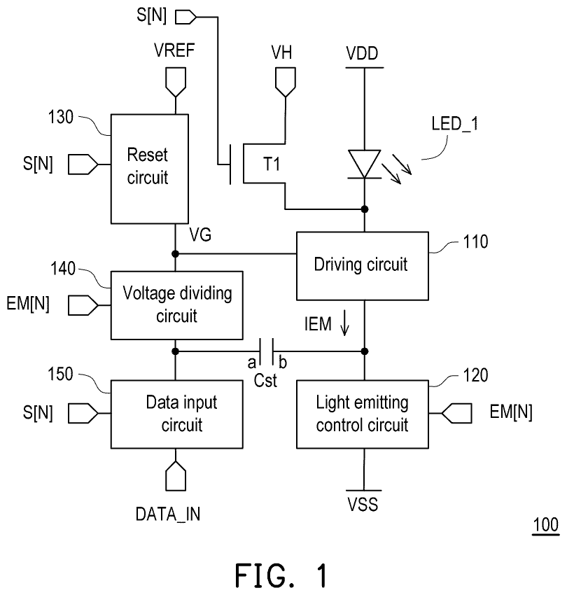

FIG. 1 is a schematic system diagram of a pixel circuit according to an embodiment of the disclosure. Please refer to FIG. 1. In the embodiment, a pixel circuit 100 may implement each of multiple pixel circuits of a pixel array, and the pixel circuit 100 includes a light emitting element (here, a micro light emitting diode LED_1 is taken as an example), a transistor T1, a capacitor Cst, a driving circuit 110, a light emitting control circuit 120, a reset circuit 130, a voltage dividing circuit 140, and a data input circuit 150.

An anode of the micro light emitting diode LED_1 receives a supply voltage VDD. A first terminal of the transistor T1 receives an operating high voltage VH, a control terminal (for example, a gate) of the transistor T1 receives a scan signal S[N], and a second terminal of the transistor T1 is coupled to a cathode of the micro light emitting diode LED_1, where N is a guide number. The capacitor Cst has a first terminal a and a second terminal b. The driving circuit 110 is coupled between the cathode of the micro light emitting diode LED_1 and the second terminal b of the capacitor Cst, and receives a driving voltage VG to provide a driving current IEM based on the driving voltage VG. The light emitting control circuit 120 is coupled between the driving circuit 110 and a ground voltage VSS, and receives a light emitting signal EM[N]. The reset circuit 130 is coupled between the reference voltage VREF and the driving voltage VG, and receives the scan signal S[N]. The voltage dividing circuit 140 is coupled between the driving voltage VG and the first terminal a of the capacitor Cst, and receives the light emitting signal EM[N]. The data input circuit 150 is coupled between the first terminal a of the capacitor Cst and a data input signal DATA_IN, and receives the scan signal S[N].

According to the above, the pixel circuit 100 may only use two control signals (that is, the scan signal S[N] and the light emitting signal EM[N]) to control the operation of the pixel circuit 100. In other words, the pixel circuit 100 may only need to use two signal lines to complete the circuit layout of the signal lines, thereby reducing the circuit area of the pixel circuit 100 to increase the aperture ratio of the pixel circuit 100.

Moreover, in the embodiment of the disclosure, each of the driving circuit 110, the light emitting control circuit 120, the reset circuit 130, the voltage dividing circuit 140, and the data input circuit 150 may be composed of a single transistor. In this case, the number of elements between the supply voltage VDD and the ground voltage VSS may be reduced to two to reduce an IR drop effect between the supply voltage VDD and the ground voltage VSS. Moreover, the transistor T1, the driving circuit 110, and the data input circuit 150 may be conducted during a compensation period, and the driving voltage VG controlling the driving current IEM may be set to the reference voltage VREF, so that the capacitor Cst stores a threshold voltage of a transistor conducting the driving circuit 110 to compensate for the threshold voltage of the transistor of the driving circuit 110.

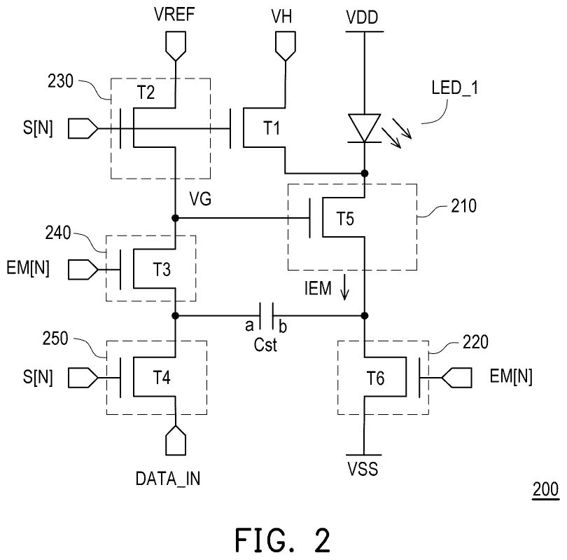

FIG. 2 is a schematic circuit diagram of a pixel circuit according to an embodiment of the disclosure. Please refer to FIG. 1 and FIG. 2. In the embodiment, the pixel circuit 100 may be implemented with reference to a pixel circuit 200, that is, the pixel circuit 200 may be regarded as an implementation example of the pixel circuit 100, wherein the same or similar reference numerals are used for the same or similar elements. In FIG. 2, the pixel circuit 200 includes the micro light emitting diode LED_1, the transistor T1, the capacitor Cst, a driving circuit 210, a light emitting control circuit 220, a reset circuit 230, a voltage dividing circuit 240, and a data input circuit 250.

In the embodiment, the reset circuit 230 includes a transistor T2. A first terminal of the transistor T2 receives the reference voltage VREF, a control terminal of the transistor T2 receives the scan signal S[N], and a second terminal of the transistor T2 is coupled to the driving voltage VG.

The voltage dividing circuit 240 includes a transistor T3. A first terminal of the

transistor T3 is coupled to the driving voltage VG, a control terminal of the transistor T3 receives the light emitting signal EM[N], and a second terminal of the transistor T3 is coupled to the first terminal a of the capacitor Cst.

The data input circuit 250 includes a transistor T4. A first terminal of the transistor T4 is coupled to the first terminal a of the capacitor Cst, a control terminal of the transistor T4 receives the scan signal S[N], and a second terminal of the transistor T4 receives the data input signal DATA_IN.

The driving circuit 210 includes a transistor T5. A first terminal of the transistor T5 is coupled to the cathode of the micro light emitting diode LED_1 and the second terminal of the transistor T4, a control terminal of the transistor T5 receives the driving voltage VG, and a second terminal of the transistor T5 is coupled to the second terminal b of the capacitor Cst and provides the driving current IEM.

The light emitting control circuit 220 includes a transistor T6. A first terminal of the transistor T6 is coupled to the second terminal b of the capacitor Cst and the second terminal of the transistor T5, a control terminal of the transistor T6 receives the light emitting signal EM[N], and a second terminal of the transistor T6 receives the ground voltage VSS.

In the embodiment, the transistors T1 to T6 are taken as N-type oxide thin-film transistors as an example, but the embodiment of the disclosure is not limited thereto.

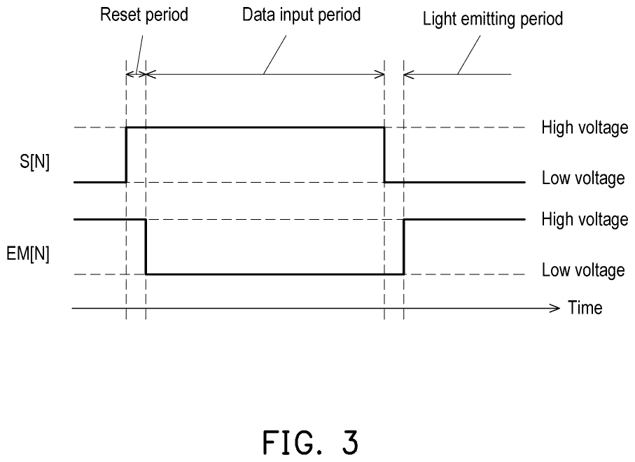

FIG. 3 is a schematic timing diagram of signals in a pixel circuit according to an embodiment of the disclosure. Please refer to FIG. 2 and FIG. 3. In the embodiment, an operation timing of a pixel circuit (for example, 100 and 200) during a single screen period may be sequentially divided into a reset period, a data input period, and a light emitting period, wherein the reset period and the data input period are used for data writing.

During the reset period, the scan signal S[N] and the light emitting signal EM[N] are enabled (such as at high voltage levels). At this time, the transistors T1 to T4 and T6 in the pixel circuit 200 are conducted. Since the transistor T1 is conducted, the operating high voltage VH is provided to the cathode of the micro light emitting diode LED_1. Since the voltage value of operating high voltage VH may be equal to or higher than the supply voltage VDD, the micro light emitting diode LED_1 is in a non-light emitting state. Since the transistors T2 to T4 are conducted, the voltages of the driving voltage VG and the first terminal a of the capacitor Cst are located between the reference voltage VREF and the voltage level of the data input signal DATA_IN, wherein the driving voltage VG is close to the reference voltage VREF, and the voltage of the first terminal a of the capacitor Cst is close to the voltage level of the data input signal DATA_IN. When the transistor T6 is conducted, the voltage of the second terminal b of the capacitor Cst (that is, the second terminal of the transistor T5) is close to the ground voltage VSS.

In the embodiment, it is assumed that the voltage level of the data input signal DATA_IN >the reference voltage VREF >the ground voltage VSS, and when a voltage difference between the voltage level of the data input signal DATA_IN and the reference voltage VREF is substantially the same as a voltage difference between the reference voltage VREF and the ground voltage VSS, the driving voltage VG is high enough to conduct the transistor T5.

During the data input period, the scan signal S[N] is enabled, and the light emitting signal EM[N] is disabled (for example, a low voltage level). At this time, the transistor T1, the transistor T2, and the transistor T4 in the pixel circuit 200 are conducted, and the transistor T3 and the transistor T6 are disconnected. Since the transistor Tl remains being conducted, the micro light emitting diode LED_1 remains in the non-light emitting state. The driving voltage VG is the reference voltage VREF, and the voltage of the second terminal b of the capacitor Cst (that is, the second terminal of the transistor T5) is equal to the reference voltage VREF minus a threshold voltage of the transistor T5, so that the transistor T5 keeps being conducted. The voltage of the first terminal a of the capacitor Cst is the voltage level of the data input signal DATA_IN. A cross voltage stored in the capacitor Cst is correlated with the data input signal DATA_IN1 and the threshold voltage of the transistor T5.

During the light emitting period, the scan signal S[N] is disabled, and the light emitting signal EM[N] is enabled. At this time, the transistor T3 and the transistor T6 in the pixel circuit 200 are conducted, and the transistor T1, the transistor T2, and the transistor T4 are not conducted.

At this time, the driving voltage VG=DATA_IN+ (VSS−VREF+VTH), and the transistor T5 is controlled by the driving voltage VG and is conducted, where DATA_IN is the voltage level of the data input signal DATA_IN, VSS is the ground voltage VSS, and VTH is the threshold voltage of the transistor T5. Moreover, the driving current IEM=½ k (DATA_IN-VREF)², where k is a dielectric coefficient, that is, the driving current IEM is not affected by the threshold voltage of the transistor T5, so the pixel circuit (for example, 100 and 200) may compensate for the threshold voltage of the transistor T5.

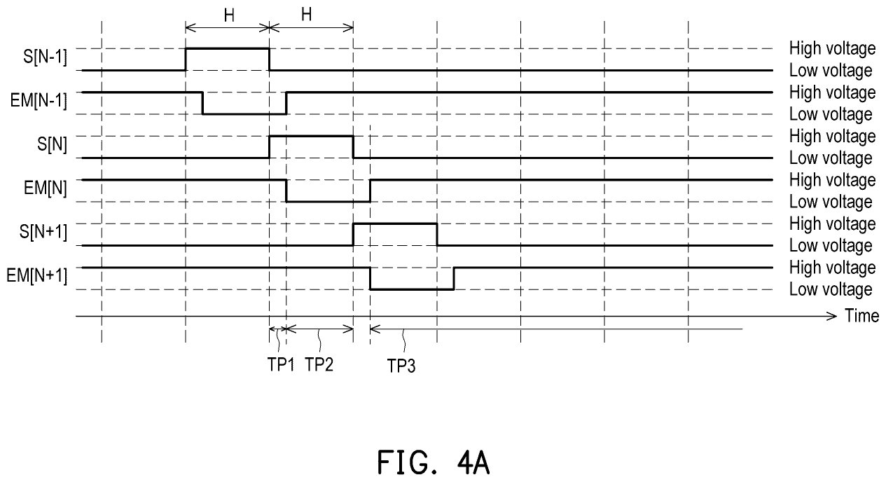

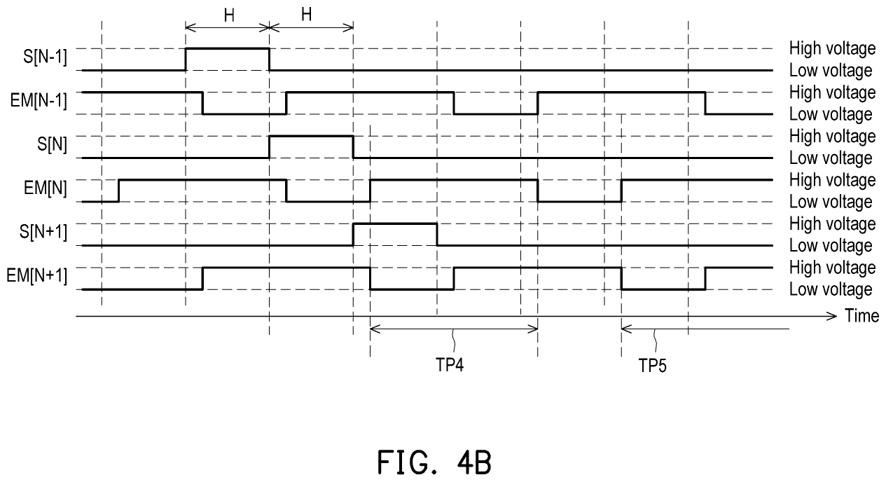

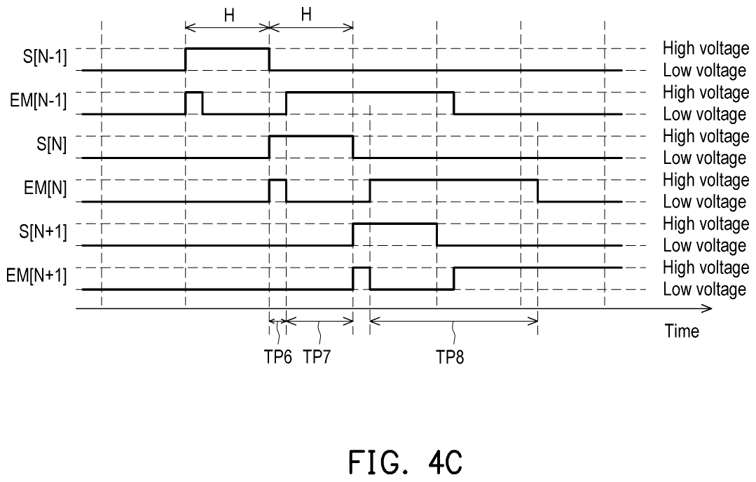

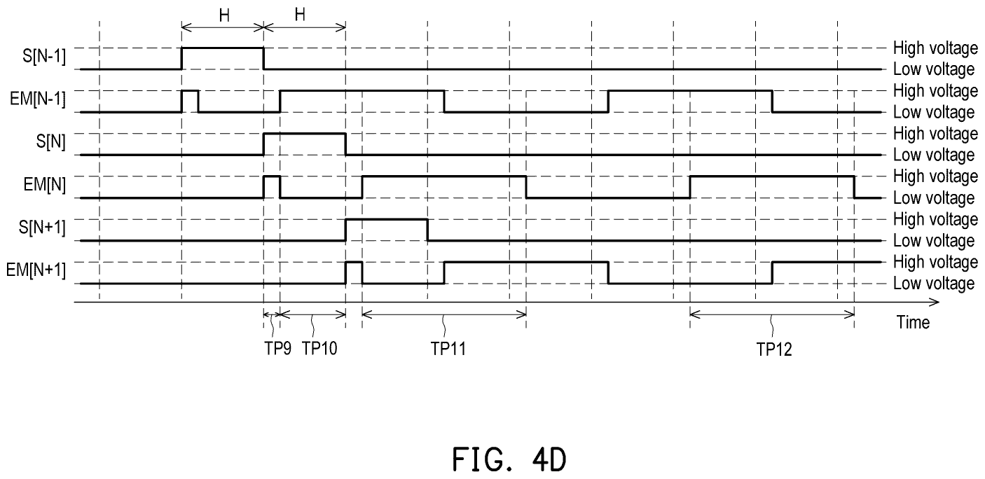

FIG. 4A is a schematic timing diagram of signals in a display device according to an embodiment of the disclosure. Please refer to FIG. 2, FIG. 3, and FIG. 4A. In the embodiment of the disclosure, in a pixel array having multiple pixel circuits (for example, the pixel circuit 200 of FIG. 2), the pixel circuits of each row respectively receive a corresponding scan signal (for example, S[N−1] to S[N+1]) and a corresponding light emitting signal (for example, EM[N−1] to EM[N+1]). In FIG. 4A, reference may be made to the embodiment of FIG. 3 for the operation of the pixel circuit (for example, the pixel circuit 200 of FIG. 2), which will not be described again here. Taking the scan signal S[N] and the light emitting signal EM[N] as an example, a time interval TP1 may correspond to the reset period of the pixel circuit 200 in FIG. 3, a time interval TP2 may correspond to the data input period of the pixel circuit 200 in FIG. 3, and a time interval TP3 may correspond to the light emitting period of the pixel circuit 200 in FIG. 3. In the embodiment, the pixel circuit (for example, the pixel circuit 200 of FIG. 2) may operate as single emission, that is, after data is written into the pixel circuit (for example, the pixel circuit 200 of FIG. 2), the light emitting signal EM[N] enables the pixel circuit (for example, the pixel circuit 200 of FIG. 2) to keep emitting light until data is written the next time.

In the embodiment, a time difference (or a phase difference) between the scan signals (for example, S[N−1] to S[N+1]) may be one horizontal scan time H, and a time difference (or a phase difference) between the light emitting signals (for example, EM[N−1] to EM[N+1]) may be one horizontal scan time H, but the embodiment of the disclosure is not limited thereto.

FIG. 4B is a schematic timing diagram of signals in a display device according to another embodiment of the disclosure. Please refer to FIG. 2, FIG. 3, FIG. 4A, and FIG. 4B. In the embodiment of the disclosure, reference may be made to the embodiment of FIG. 3 for the operation of the pixel circuit (for example, the pixel circuit 200 of FIG. 2), and the operation of the pixel circuit (for example, the pixel circuit 200 of FIG. 2) may operate as multi emission. In other words, after data is written into the pixel circuit (for example, the pixel circuit 200 of FIG. 2) and before data is written the next time, the light emitting signal EM[N] enables the pixel circuit (for example, the pixel circuit 200 of FIG. 2) to light up multiple times, that is, the pixel circuit (for example, the pixel circuit 200 of FIG. 2) is lit up during multiple different light emitting periods (for example, a time interval TP4 and a time interval TP5) until data is written the next time.

FIG. 4C is a schematic timing diagram of signals in a display device according to another embodiment of the disclosure. Please refer to FIG. 2, FIG. 3, FIG. 4A, and FIG. 4C. In the embodiment of the disclosure, reference may be made to the embodiment of FIG. 3 for the operation of the pixel circuit (for example, the pixel circuit 200 of FIG. 2), and the pixel circuit (for example, the pixel circuit 200 of FIG. 2) may operate as single emission. The difference between FIG. 4A and FIG. 4C is that the scan signal S[N] and the light emitting signal EM[N] of FIG. 4C are at low voltages before a reset period (a time interval TP6), and after a data write period (a time interval TP7), the light emitting signal EM[N] only lights up the pixel circuit (for example, the pixel circuit 200 of FIG. 2) during a light emitting period (a time interval TP8).

FIG. 4D is a schematic timing diagram of signals in a display device according to another embodiment of the disclosure. Please refer to FIG. 2, FIG. 3, FIG. 4C, and FIG. 4D. In the embodiment of the disclosure, reference may be made to the embodiment of FIG. 3 for the operation of the pixel circuit (for example, the pixel circuit 200 of FIG. 2), and the pixel circuit (for example, the pixel circuit 200 of FIG. 2) may operate as multi emission. In the embodiment, the scan signal S[N] and the light emitting signal EM[N] of FIG. 4D are at low voltages before a reset period (a time interval TP9), and after a data write period (a time interval TP10), the light emitting signal EM[N] lights up the pixel circuit (for example, the pixel circuit 200 of FIG. 2) during multiple light emitting periods (time intervals TP11 and TP12).

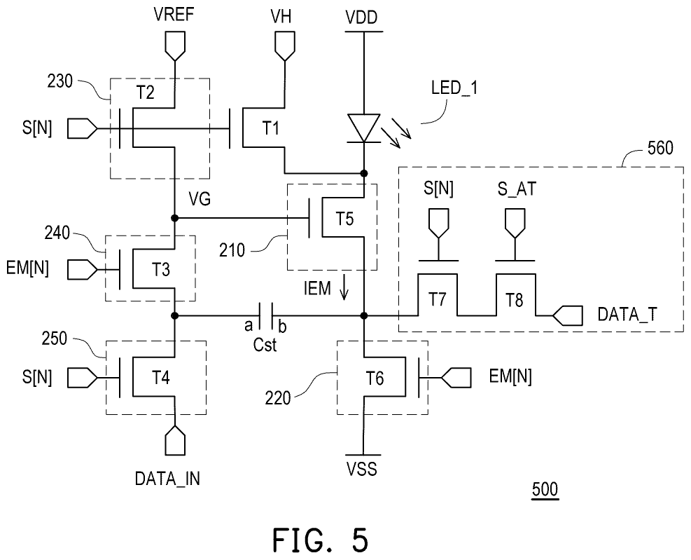

FIG. 5 is a schematic circuit diagram of a pixel circuit according to another embodiment of the disclosure. Please refer to FIG. 2 and FIG. 5. In the embodiment, a pixel circuit 500 may be substantially the same as the pixel circuit 200, wherein the same or similar elements use the same or similar reference numerals. The difference between the pixel circuit 500 and the pixel circuit 200 is that the pixel circuit 500 further includes a test circuit 560.

The test circuit 560 is coupled to the second terminal b of the capacitor Cst and receives the scan signal S[N], a test activation signal S_AT, and a test data signal DATA_T. The test circuit 560 may transmit the test data signal DATA_T to the second terminal b of the capacitor Cst according to the scan signal S[N] and the test activation signal S_AT.

In the embodiment, the test circuit 560 includes a transistor T7 and a transistor T8, wherein the transistors T7 and T8 are taken as N-type oxide thin-film transistors as an example, but the embodiment of the disclosure is not limited thereto. A first terminal of the transistor T7 is coupled to the second terminal b of the capacitor Cst, a control terminal of the transistor T7 receives the scan signal S[N], and a second terminal of the transistor T7 is coupled to a first terminal of the transistor T8. A control terminal of the transistor T8 receives the test activation signal S_AT, and a second terminal of the transistor T8 receives the test data signal DATA_T.

In the embodiment, when the scan signal S[N] and the test activation signal S_AT are both enabled, the transistor T7 and the transistor T8 are conducted, and the test data signal DATA_T may be transmitted to the second terminal b of the capacitor Cst. When one of the scan signal S[N] and the test activation signal S_AT is disabled, one of the transistor T7 and the transistor T8 is disconnected, so that the test data signal DATA_T is not transmitted to the second terminal b of the capacitor Cst.

In summary, in the pixel circuit of the embodiment of the disclosure, the pixel circuit may only use two control signals (that is, the scan signal and the light emitting signal) to control the operation of the pixel circuit. In other words, the pixel circuit may only need to use two signal lines to complete the circuit layout of the signal lines, thereby reducing the circuit area of the pixel circuit to increase the aperture ratio of the pixel circuit.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A pixel circuit, comprising:
a light emitting element, having an anode and a cathode receiving a supply voltage;
a first transistor, having a first terminal receiving an operating high voltage, a control terminal receiving a scan signal, and a second terminal coupled to the cathode of the light emitting element;
a capacitor, having a first terminal and a second terminal;
a driving circuit, coupled between the cathode of the light emitting element and the second terminal of the capacitor and receiving a driving voltage to provide a driving current based on the driving voltage;
a light emitting control circuit, coupled between the driving circuit and a ground voltage, and receiving a light emitting signal;
a reset circuit, coupled between a reference voltage and the driving voltage, and receiving the scan signal;
a voltage dividing circuit, coupled between the driving voltage and the first terminal of the capacitor, and receiving a light emitting signal; and
a data input circuit, coupled between the first terminal of the capacitor and a data input signal, and receiving the scan signal.

2. The pixel circuit according to claim 1, wherein the reset circuit comprises:
a second transistor, having a first terminal receiving the reference voltage, a control terminal receiving the scan signal, and a second terminal coupled to the driving voltage.

3. The pixel circuit according to claim 2, wherein the voltage dividing circuit comprises:
a third transistor, having a first terminal coupled to the driving voltage, a control terminal receiving the light emitting signal, and a second terminal coupled to the first terminal of the capacitor.

4. The pixel circuit according to claim 3, wherein the data input circuit comprises:
a fourth transistor, having a first terminal coupled to the first terminal of the capacitor, a control terminal receiving the scan signal, and a second terminal coupled to the data input signal.

5. The pixel circuit according to claim 4, wherein the driving circuit comprises:
a fifth transistor, having a first terminal coupled to the cathode of the light emitting element, a control terminal receiving the driving voltage, and a second terminal coupled to the second terminal of the capacitor.

6. The pixel circuit according to claim 5, wherein the light emitting control circuit comprises:
a sixth transistor, having a first terminal coupled to the second terminal of the capacitor, a control terminal receiving the light emitting signal, and a second terminal receiving the ground voltage.

7. The pixel circuit according to claim 6, wherein the first transistor, the second transistor, the third transistor, the fourth transistor, the fifth transistor, and the sixth transistor are all N-type transistors.

8. The pixel circuit according to claim 1, further comprising:
a test circuit, coupled to the second terminal of the capacitor and receiving the scan signal, a test activation signal, and a test data signal to transmit the test data signal to the second terminal of the capacitor based on the scan signal and the test activation signal.

9. The pixel circuit according to claim 8, wherein the test circuit comprises:
a seventh transistor, having a first terminal coupled to the second terminal of the capacitor, a control terminal receiving the scan signal, and a second terminal; and
an eighth transistor, having a first terminal coupled to the second terminal of the seventh transistor, a control terminal receiving the test activation signal, and a second terminal receiving the test data signal.

10. The pixel circuit according to claim 1, wherein the light emitting element is a micro light emitting diode.
